(19) United States
(12) Patent Application Publication
(10) Pub. No.: US 2016/0091386 A1
(43) Pub. Date: Mar. 31, 2016

(54) Sniffing Leak Detector Having a Nanoporous Membrane

(71) Applicant: INFICON GMBH, Köln (DE)

(72) Inventor: Ludolf Gerdau, Elsdorf (DE)

(21) Appl. No.: 14/892,397

(22) PCT Filed: May 14, 2014
(86) PCT No.: PCT/EP2014/059845

§ 371 Date: Nov. 19, 2015

(30) Foreign Application Priority Data
May 22, 2013 (DE) 10 2013 209 438.8

(51) Int. Cl. G01M 3/20

(52) U.S. Cl. CPC G01M 3/205

(57) ABSTRACT

A sniffing leak detector for sucking in and analyzing gas, including a sniffing probe for sucking in the gas, a gas-conveying pump connected to the sniffing probe, and a mass spectrometer connected to a vacuum pump for analyzing the sucked-in gas in a high vacuum. The gas flow through the sniffing probe is conducted along a membrane having gas-permeable pores. The membrane allows part of the gas to flow into the prevacuum of the vacuum pump for the mass spectrometric analysis of the gas in a high vacuum. The diameter of the pores is less than or equal to the free path of air at atmospheric pressure and room temperature in order to improve the detection limit of the sniffing leak detector.

The invention relates to a sniffing leak detector for sucking in a gas to be analyzed.

A sniffing leak detector serves to analyze gas and is provided with a sniffing probe for sucking in the gas to be analyzed. The gas analysis is typically performed in a high vacuum using a mass spectrometer. In a mass-spectrometric gas analysis, air at atmospheric pressure (ambient air) is typically sucked in in the vicinity of a suspected leak in a test object. The test object is filled with a test gas such as hydrogen or helium, for example. The test gas pressure inside the test object is higher than the atmospheric pressure in the ambient environment so that the test gas escapes from a leak in the test object and gets into the air in the vicinity of the test object. The air sucked in by means of the sniffing probe is supplied, either in the main flow or the partial flow, into the high vacuum, where the partial pressure of the test gas (hydrogen or helium) is measured.

The detection limit of the sniffing leak detector for the test gas is a critical measure of the quality of measurement. The detection limit is the minimal detectable concentration of the test gas in the air sucked in. The lower the detection limit is, the more sensitive is the measuring system and the higher is the accuracy with which the proportion of test gas can be determined.

It is known to arrange a gas-permeable membrane in the gas inlet to the high vacuum of the mass spectrometer, through which membrane a part of the gas sucked in flows. The known membranes are sintered ceramics discs intended to prefer the comparatively light test gas helium or hydrogen and to let less of the heavier gas proportions pass. The known sintered ceramics discs are suited for a mass-spectrometric gas analysis with a direct gas inlet into the high vacuum of the mass spectrometer (total pressure <10⁻⁴ mbar). With a gas inlet into the prevacuum of the high vacuum pump, such as with a counterflow leak detector, the conductance is insufficient to create the required gas flow that is greater by approx. a factor of 100.

It is an object of the invention to improve the detection limit of a sniffing leak detector for mass-spectrometric gas analysis by providing for a sufficiently high, but still molecular conductance that prefers the entry of hydrogen into the air over the entry of heavier gases.

The sniffing leak detector of the present invention is defined by the features of claim 1.

In the sniffing leak detector of the present invention, the gas inlet to the mass spectrometer is effected through a membrane through which the gas sucked in flows, with the pore diameter of the membrane being smaller or equal to the free path of air at atmospheric pressure and room temperature. A pressure in a range from 950 hPa to 1050 hPa is considered to be atmospheric pressure. A temperature in a range from 15° C. to 25° C. is considered to be room temperature. According to the invention it has been found that pores with a diameter which corresponds at most to the free path of air at atmospheric pressure and room temperature, generate a molecular gas flow even at a relatively high pressure as prevails in front of the inlet membrane of a sniffing leak detector. The conductance for the light test gases hydrogen or helium is particularly high, while the conductance for the heavier gases, which are unwanted in the analysis, is low. This creates a molecular gas flow into the vacuum, which flow contains test gas and is not viscous, but in which the molecules move independently of each other and at different velocities. The light gases, among the test gases hydrogen and helium belong, move particularly fast, whereby their proportion is greater in the high vacuum than in the sucked-in gas flow, and the detection limit is thereby improved. With the previous sintered membrane technology, a certain enrichment would also be achieved, yet the gas flow let in would be so small that the detection limit would even be worse than in case of a direct inlet (e.g. via an orifice).

Thus, the invention is based on the idea to design the pore openings as small as possible and, preferably, to make their diameters as equal as possible. In this regard, it is particularly advantageous to provide as many pores as possible in order to allow the passage of a comparatively large gas quantity despite the small pore size.

Similar membranes are known from a different technical field—namely the ultra-filtration of macro-molecules in liquids—where they do not serve for the improvement of the detection limit of a sniffing leak detector, but for a defined filtering of macromolecules with high accuracy.

The pore diameter may for example be less than or equal to 20 nanometers (nm). The diameter of any pore should differ from the mean diameter of all pores by about 50% at most, preferably by about 20% at most, so that the pores are as similar in size as possible such that even with high pressure differences no unwanted, heavy gases will be passed.

In order to still allow a sufficiently large proportion of gas to pass, the surface ratio of all pores should be at least about 20% and preferably at least about 40% of the total membrane surface area. The surface ratio of all pores may be in a range from 25% to 50% of the membrane surface area.

The pore density should be as high as possible. Preferably, the membrane should have at least 20 and preferably at least 25 pores per square micrometer (μm²) of its surface area. The wall thickness between adjacent pores, i.e. the smallest distance between the edges of adjacent pores, should be as small as possible and be less than 100 nm and preferably less than 80 nm.

The disc thickness of the membrane should be less than 100 μm and preferably less than 50 μm and possibly only a few 10 μm or less so as to keep the length of the pores as short as possible.

It is particularly advantageous if the quotient of the mean diameter of all pores and the mean free path of the sucked-in gas (air) is greater than 0.5 at atmospheric pressure and room temperature. For the mean free path I and the pressure p of the sucked-in air, the following is true:

Ī·p=6.65·10⁻⁵ m·mbar (at 273.15 K)

from which a mean free path of

$$\frac{6.65 \cdot {10}^{- 5} m \cdot mbar}{1000 mbar} = 66.5 nm$$

is obtained at about 1000 mbar.

With the sniffing leak detector of the present invention it is possible to generate the maximum high vacuum pressure of 10⁻⁴ mbar with the gas let in in counterflow via the prevacuum, which pressure provides the best possible detection limit in a mass-spectrometric gas analysis.

The features of the invention can be realized in a particularly simple and reliable manner in a nanoporous membrane of aluminum oxide.

The following is a detailed description of an embodiment of the invention with reference to the drawings. In the Figures:

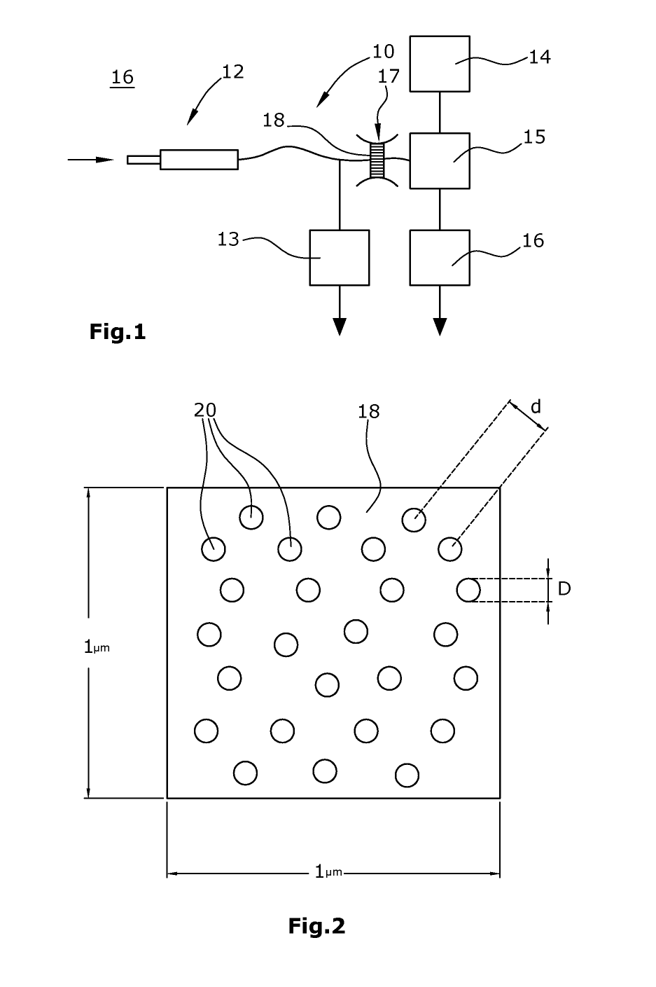

FIG. 1 is a schematic illustration of the sniffing leak detector and

FIG. 2 is a microscopic detail of a plan view of a membrane.

FIG. 1 illustrates the sniffing leak detector 10 of the present invention which consists of a sniffing probe 12, a conveying pump 13, a mass spectrometer 14 and a vacuum pump 15, 16. The sniffing probe 12 is connected in a gas-conducting manner with the conveying pump 13 to suck gas through the sniffing probe 12. The gas sucked in by the conveying pump 13 through the sniffing probe 12 is supplied to the gas inlet 17 of a turbomolecular pump 15. Together with an associated backing pump 16, the turbomolecular pump 15 forms the vacuum pump 15, 16 for the mass spectrometer 14. The gas inlet 17 comprises a gas-permeable porous membrane 18 through which the gas is sucked into the turbomolecular pump 15. For this purpose, the turbomolecular pump 15 is connected in a gas-conducting manner with the mass spectrometer 14 in order to evacuate the same. No valves or pressure measuring devices are required.

The mass-spectrometric sniffing leak detector 10 is a counterflow leak detector for light gases. The gas is introduced into the prevacuum of the vacuum pump 15, 16 and not into the high vacuum of the mass spectrometer 14. In doing so, the light proportion of the sucked-in gas preferably diffuses into the mass spectrometer 14. As a result, a large gas quantity can be sucked in in order to achieve a particularly high sensitivity, whereas the light gas is enriched via the membrane 18.

A microscopic detail of a top plan view of the surface of the membrane 18 is illustrated in FIG. 2. The membrane 18 has a plurality of pores 20 which are arranged statistically in even distribution over the surface of the membrane 18. Each pore 20 penetrates the membrane 18 completely. The membrane is a disc with a thickness of about 30 μm so that the length of each pore 20 is about 30 μm. The length of each pore 20 is thus equal to the thickness of the membrane 18.

FIG. 2 shows that the membrane 18 has about 26 pores per μm² of its surface. The mean smallest distance d between adjacent pores 20 (centre-centre) is 100 nm. Mean smallest distance means the mean value of all smallest distances of directly adjacent pores measured from centre to centre of the pores. The mean diameter D of all pores 20 is 20 nm and, in an alternative embodiment, may also be less than 20 nm.

The surface ratio of all pores 20 with respect to the surface area of the membrane 18 is 50% so that, on the whole, half the membrane surface is designed to be gas-permeable.

Thus, the invention is based on the idea that the gas inlet is not constituted by an orifice with only one opening, but rather by a gas-porous membrane whose individual holes, at the pressure prevailing at the gas inlet, meet Knudsen's condition for molecular flows. The hole density is chosen so high that, despite the small pore size, such a quantity of gas is allowed to pass that the high vacuum pressure of 10⁻⁴ mbar can be obtained. In this regard, the physical law is used according to which, in a molecular gas flow, the gas proportions of a gas flow move independently of each other (molecularly) and each have a conductance of their own. Molecular conductances are inversely proportional to the square root of the molecular weight of the respective gas. Therefore, hydrogen has a significantly better conductance through a given opening than nitrogen and oxygen, as well as all other components of air.

1. A sniffing leak detector for sucking in and analyzing gas, comprising a sniffing probe for sucking in the gas, a gas-conveying pump connected to the sniffing probe, and a mass spectrometer connected to a vacuum pump for analyzing the sucked-in gas in a high vacuum, wherein the gas flow through the sniffing probe is conducted along a membrane having gas-permeable pores, wherein the membrane allows part of the gas to flow into the prevacuum of the vacuum pump for the mass-spectrometric analysis of the gas in a high vacuum,
wherein
the diameter of the pores is less than or equal to the free path of air at atmospheric pressure and room temperature.

2. A sniffing leak detector, wherein the mass-spectrometric sniffing leak detector is a counterflow leak detector.

3. The sniffing leak detector of claim 1, wherein the pore diameters are each less than or equal to 20 nm.

4. The sniffing leak detector of claim 1, wherein a diameter of each pore differs from a mean diameter of all pores of the membrane by a maximum of 50%.

5. The sniffing leak detector of claim 1, wherein a total surface ratio of all pore openings is at least 25% of a total surface area of the membrane.

6. The sniffing leak detector of claim 1, wherein the membrane is a disc with a thickness of less than 100 μm.

7. The sniffing leak detector of claim 1, wherein the membrane is a nanoporous disc of aluminum oxide.

8. The sniffing leak detector of claim 1, wherein a smallest distance between adjacent pores is less than 100 nm.

9. The sniffing leak detector of claim 1, wherein the membrane has at least 20 pores per μm² of its surface area.

10. The sniffing leak detector of claim 1, wherein a ratio of pore diameter and mean free path of the sucked-in gas (Knudsen number) is higher than 0.5, where: I·p=6.65·10−5 m·mbar applies for the mean free path I and the pressure p of the sucked-in gas.

11. The sniffing leak detector of claim 1, wherein a diameter of each pore differs from a mean diameter of all pores of the membrane by less than 20%.

12. The sniffing leak detector of claim 1, wherein a total surface ratio of all pore openings is at least 40% of a total surface area of the membrane.

13. The sniffing leak detector of claim 1, wherein the membrane is a disc with a thickness of less than 50 μm.

14. The sniffing leak detector of claim 1, wherein a smallest distance between adjacent pores is less than 80 nm.

15. The sniffing leak detector of claim 1, wherein the membrane has at least 25 pores per μm² of its surface area.
